(19) United States
(12) Patent Application Publication
(10) Pub. No.: US 2018/0134918 A1
(43) Pub. Date: May 17, 2018

(54) SOFT POLYMER-BASED MATERIAL POLISHING MEDIA

(71) Applicant: JH Rhodes Company, Inc., Phoenix, AZ (US)

(72) Inventor: Scott Daskiewich, Oriskany, NY (US)

(21) Appl. No.: 15/808,643

(22) Filed: Nov. 9, 2017

Related U.S. Application Data
(60) Provisional application No. 62/421,187, filed on Nov. 11, 2016.

(51) Int. Cl. C09G 1/16; B24B 1/00; C09G 1/02; C09K 3/14

(52) U.S. Cl. CPC C09G 1/16; C09K 3/14; C09G 1/02; B24B 1/00

(57) ABSTRACT

Polishing media including a soft polymer-based material, apparatus and systems including the media, and methods of forming and using the media, apparatus, and systems are disclosed.

### CROSS-REFERENCE TO RELATED APPLICATION

This application claims the benefit of U.S. Provisional Application Patent Application Ser. No. 62/421,187, filed Nov. 11, 2016, and entitled SOFT POLYMER-BASED MATERIAL POLISHING MEDIA, the contents of which are hereby incorporated herein by reference, to the extent such contents do not conflict with the present application.

### FIELD OF DISCLOSURE

The present disclosure generally relates to materials suitable for use as polishing media, such as polishing pads. More particularly, the disclosure relates to polishing materials and media formed of soft polymer-based material and to methods of forming and using the materials and media.

### BACKGROUND OF THE DISCLOSURE

Polishing workpiece surfaces can be used in a variety of applications. For example, polishing can be used to finish a glass surface, such as a glass surface used for displays of smart devices, for chemical-mechanical planarization in the formation of electronic devices, and the like. In the case of finishing surfaces, polishing can follow grinding and/or lapping processes to remove or reduce surface damage on surfaces.

To polish a surface of a workpiece, a polishing medium, such as a polishing pad, is placed adjacent to the workpiece and moved relative to the workpiece surface. This relative movement can be created by rotating the medium, by rotating the workpiece, by orbital movement of the workpiece or media, by linear movement of the workpiece or medium, or a combination of such movements. Additionally or alternatively, linear or any other useful relative motion between the medium and the workpiece can be used. A force can be applied to press the medium against the workpiece surface during the lapping or polishing process. A slurry, including abrasive particles, can also be used during the processing to facilitate material removal from the workpiece surface.

Use of typical polishing pads can work well to remove material from a planar surface. However, such polishing pads are generally not well suited to polish workpieces with nonplanar (e.g., curved) surfaces, such as rounded edges, or surfaces with other features thereon. Accordingly, improved polishing media and methods are desired.

### SUMMARY OF THE DISCLOSURE

Various embodiments of the present disclosure relate to improved polishing materials and media. While the ways in which exemplary embodiments of the present disclosure address drawbacks of prior polishing media are discussed in more detail below, in general, various embodiments of the disclosure provide polishing materials and media that include a soft polymer-based material. The polishing materials and media can additionally include polymer material, such as particles or pieces of polymer material. The polymer material can be in the form of, for example, bristles, cubes, cylinders, and/or other three-dimensional structures. The polymer material particles and/or bristles facilitate material removal around corners, edges, and other features on a workpiece surface, while maintaining desired material removal rates from the surface. Exemplary polishing materials and media can be used to polish relatively hard materials, such as glass, semiconductor materials and materials used in the fabrication of electronic devices, as well as materials having a hardness greater than the hardness of typical glass—e.g., toughened aluminosilicate glass or sapphire.

In accordance with exemplary embodiments of the disclosure, a medium for polishing a surface of a workpiece includes soft polymeric material having a tensile modulus of about 50 kPa to about 1.0 MPa, about 50 kPa to about 500 kPa, or about 100 kPa to about 300 kPa. Use of such soft polymeric material facilitates removal of material from a workpiece surface, including nonplanar portions of the surface, such as rounded edges and other features of the surface. As set forth in more detail below, the inventor surprisingly and unexpectedly found that use of materials and media as set forth herein can be used to remove material from planar surface as customarily found in the industry, as well and such nonplanar surfaces with relatively high removal rates.

In accordance with various aspects of the exemplary embodiments, a compressibility at 300 gf/cm² of the soft polymer-based material is between about 40% and about 80%, about 50% and about 70%, or about 55% and about 65%. The soft polymer-based material can include one or more of a plastisol (a plastic resin and a plasticizer), a hydrogel (e.g., a polyacrylamide or polymacon hydrogel), an organogel (e.g., an organogel comprising one or more of 4-tertbutyl-1-aryl cyclohecanol derivatives; polymeric organogels, such as PEG, polycarbonate, polyesters, polyalkene, or N-lauroyl-L-lysine ethyl ester) and a silicone gel (e.g., polysiloxane or polydimethylsiloxane). As noted above, the polishing media can also include polymer material at least partially dispersed in the soft polymer-based material. The polymer material can be present in about 0 to about 50%, about 5 wt. % to about 20 wt. %, or about 5 wt. % to about 10 wt. %. Exemplary polymer material can include one or more of a polyurea, a polyurethane, and a polyurethane/polyurea hybrid material, any of which can be foamed, and/or bristles. The polymer material can extend beyond a surface of the soft polymer-based material to provide polymer material surfaces for polishing the workpiece surface. The polishing medium can also include vias formed through the soft polymer-based material. The vias can facilitate adherence of the soft polymer-based material to a plate or other surface. Exemplary polishing material can also include one or more of fillers, abrasives, and the like. Further, the soft polymer-based material can include features formed on a surface (e.g., a surface that contacts a workpiece during a polishing process) to facilitate material removal from the workpiece surface.

In accordance with further embodiments of the disclosure, a polishing apparatus includes a polishing medium as described herein. The polishing apparatus can further include a plate to which the polishing medium is attached.

In accordance with yet further exemplary embodiments of the disclosure, a polishing system includes a polishing apparatus as described herein. The polishing system can further include a polishing machine and/or a slurry.

In accordance with additional embodiments of the disclosure, a method of forming a medium for polishing a surface of a workpiece is provided. An exemplary method includes the steps of mixing one or more plastic resins and one or more plasticizers to form a mixture, heating the mixture to dissolve the plastic resin in the plasticizer to form a composition, pouring the composition into a mold, and allowing the composition to cool to thereby form a soft polymer-based polishing medium. Exemplary methods can further include mixing one or more polymer materials, abrasives, and/or fillers with the one or more plastic resins, the one or more plasticizers, and/or the mixture. Other exemplary methods are described below.

And, in accordance with yet further exemplary embodiments of the disclosure, a method of removing material from a workpiece surface includes using a polishing medium as described herein, a polishing apparatus as described herein, a polishing system as described herein, and/or polishing media formed as described herein.

### BRIEF DESCRIPTION OF THE DRAWING FIGURES

A more complete understanding of the embodiments of the present disclosure may be derived by referring to the detailed description and claims when considered in connection with the following illustrative figures.

FIG. 1 illustrates a polishing medium in accordance with various exemplary embodiments of the disclosure.

FIG. 2 illustrates another polishing medium in accordance with additional exemplary embodiments of the disclosure.

FIG. 3 illustrates a polishing apparatus in accordance with further exemplary embodiments of the disclosure.

FIG. 4 illustrates a plate and mold for forming polishing media in accordance with exemplary embodiments of the disclosure.

FIG. 5 illustrates a polishing media formed within a mold in accordance with yet additional exemplary embodiments of the disclosure.

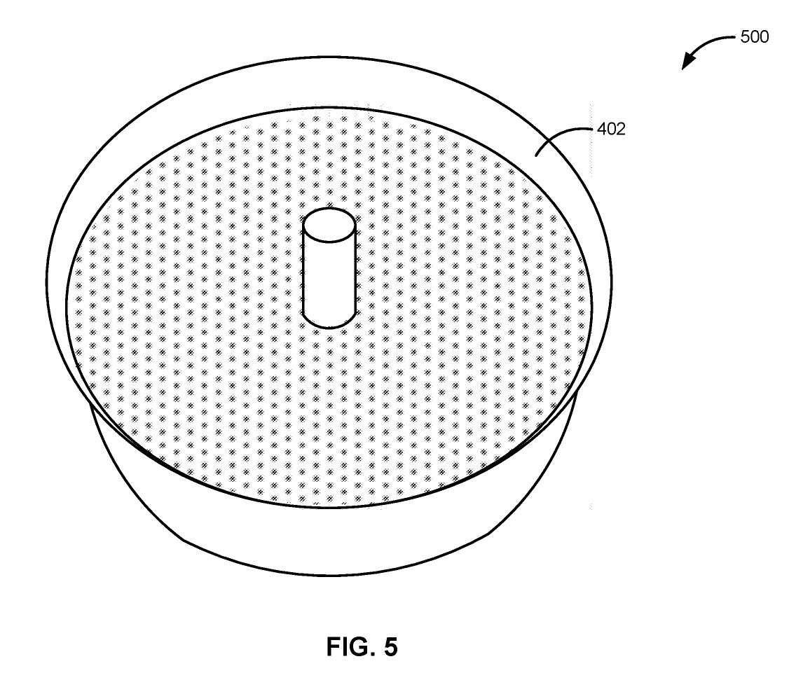

FIG. 6 illustrates a polishing system in accordance with further exemplary embodiments of the disclosure.

FIG. 7 illustrates exemplary workpieces in accordance with yet additional embodiments of the disclosure.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present disclosure.

### DETAILED DESCRIPTION OF EXEMPLARY EMBODIMENTS OF THE DISCLOSURE

The description of exemplary embodiments of materials, media, systems, apparatus, and methods of forming and using the materials, media, systems, and apparatus provided below is merely exemplary and is intended for purposes of illustration only; the following description is not intended to limit the scope of the disclosure or the claims. Moreover, recitation of multiple embodiments having stated features, compositions, or properties is not intended to exclude other embodiments having additional features, compositions, or properties, or other embodiments incorporating different combinations of the stated features, compositions, or properties, unless otherwise noted herein.

Exemplary materials, media, apparatus, and systems as described herein can be used to polish surfaces of a workpiece. By way of examples, materials, media, apparatus, systems, and methods as described herein can be used to polish glass, such as toughened aluminosilicate glass, semiconductor material, materials used to form electronic devices and/or hard-surface materials, such as sapphire (e.g., the A, C, or R planes of sapphire), other gem stones, such as emeralds and rubies, ceramics, metals, such as titanium, and similar materials. As used herein, the term “hard surface” or “hard-surface material” means a material having a hardness greater than the hardness of conventional hard silica glass (e.g., greater than about 1550 HB Brinell scale or about 7 Moh's scale). For example, the materials, media, apparatus, and systems as described herein can be used to polish surfaces that have undergone grinding and/or lapping processes or for chemical-mechanical planarization processes, such as CMP processes customarily used in semiconductor processing or other planarization processes.

By way of particular examples, the workpiece includes glass, such as toughened aluminosilicate glass, used in the manufacture of displays or covers for devices, such as smart phones or other personal electronic devices. The workpiece can include nonplanar surfaces, such as curved or rounded edges, to provide a smooth surface and/or reduce a risk of chipping or cracking of the workpiece.

As noted above, typical polishing pads may not be particularly well suited for polishing curved edges of a workpiece. In contrast, various embodiments of polishing media and methods described herein can be used to polish surfaces that include nonplanar portions, such as curved edges, while maintaining desired material removal rates from the workpiece surface.

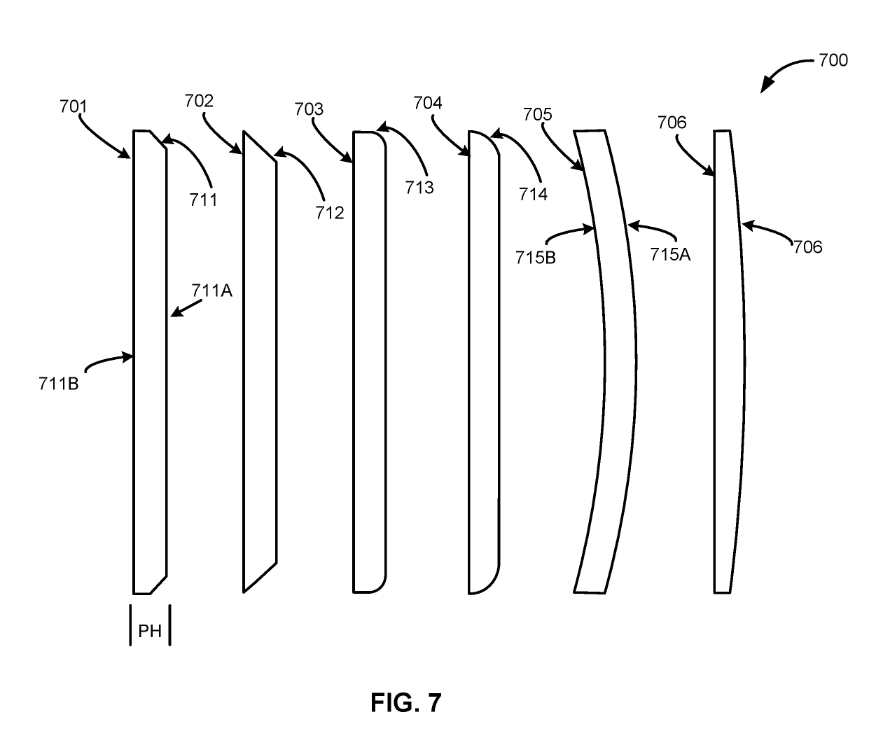

FIG. 7 illustrates various example nonplanar workpieces. Throughout this description, the term nonplanar workpiece is intended to describe a workpiece having at least one surface that comprises at least one portion of that surface that is not planar with regard to another portion of the workpiece. Similarly, the term nonplanar surface is intended to mean a surface that comprises at least one portion of that surface that is not planar with respect to another portion of the surface. In an example embodiment, a nonplanar surface comprises at least one portion of the surface that is planar (a planar portion), e.g., portion 711A, and at least one portion whose surface is not in the same plane as the surface of the planar portion 711A (a nonplanar portion), e.g., portion 711.

Thus, in an example embodiment, the workpiece to be polished may comprise a workpiece (e.g., workpiece 701, 702, 703, or 704) having a flat portion in the middle of the workpiece (e.g., portion 711A in workpiece 701) and nonplanar portions (e.g., portions 711, 712, 713, 714) near the edges of the workpiece. For example, an area of a workpiece near the edges could have a rounded edge with a radius of curvature (e.g., rounded edges 713, 714), a bevel (e.g., edges 711, 712), a taper, a parabolic shape (e.g., edge 714), a rounded shape, or the like. An edge portion of the surface of the workpiece can include any suitable nonplanar shape.

A workpiece can include an edge that is at a 90 degree angle to a top surface (e.g., surface 711A) and a bottom surface (e.g., surface 711B) and those surfaces (711A and 711B) are typically flat and parallel. In an example embodiment, curved workpieces may differ in that one or more surfaces have a curvature that is described by one of the following: (1) edges have a radius of curvature slightly larger than the part height (“PH”) that then tapers into a surface that has a radius of curvature much larger than the PH which constitutes a nearly flat surface (the other surface is flat in this case); (2) one surface is flat with 90 degree edges that extend to approximately ½ of the PH where then a radius of curvature similar in size to the PH extends to the other surface where the remaining surface across the workpiece has a radius of curvature that is much larger than the PH and is nearly flat; and (3) one surface is flat and the other surface is made entirely of a curved surface (e.g., workpiece 706 and entirely curved surface 716) with a radius of curvature much larger than the PH. In each of the above three cases, the workpiece could have both sides curved in some combination of the above three examples. For example, workpiece 705 has both surfaces 715A, 715B curved over the entire surface of the workpiece. The glass workpieces, from a top (face) view could also be round, square, rectangular or some other geometry. In an example embodiment, the workpiece may have a non-continuous radius of curvature across an entire surface. Stated another way, the workpiece may have no planar portions.

In one example embodiment, PH is measured at the point of greatest thickness of the glass object before polishing. In another example embodiment, PH is less than or equal to the greatest thickness of the glass, but not less than the greatest minimum finished thickness of the glass. The PH can be, for example, from 0.01 inch to 1 inch or from 0.05 inch to 0.25 inch. Other part heights can also be used.

In accordance with various embodiments, polishing media is configured in a manner that the media can polish nonplanar surfaces. Stated another way, the media is configured to remove evidence of lapping damage or otherwise remove material on the nonplanar portions as well as on any planar portions of the workpiece more effectively, compared to pads that are not so configured.

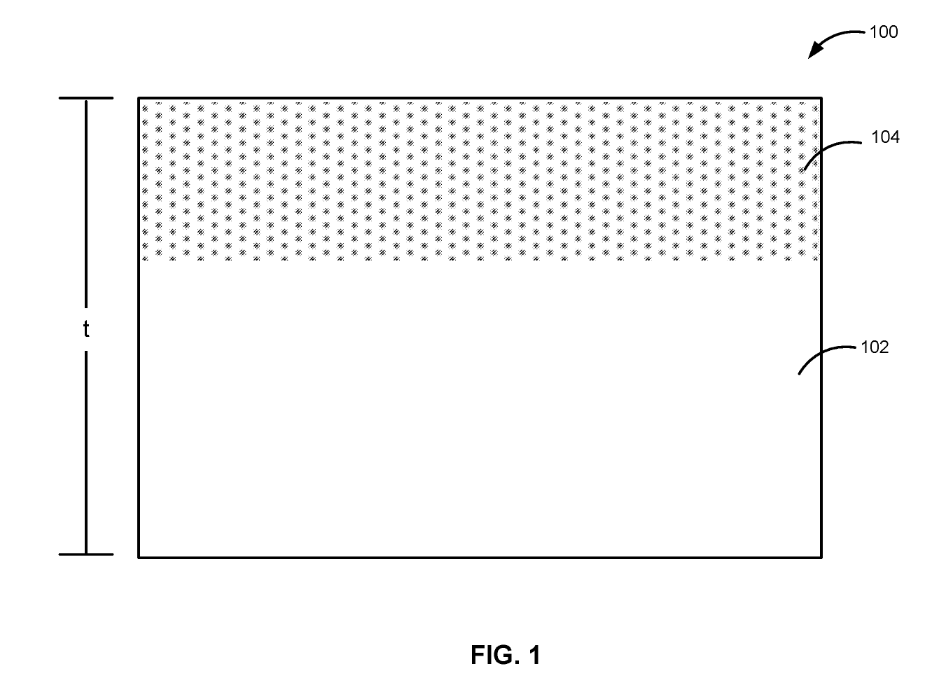

FIG. 1 illustrates polishing media 100 in accordance with various examples of the disclosure. Polishing media 100 includes soft polymer-based material 102. To facilitate removal of material from nonplanar surfaces and/or features, soft polymer material 102 is relatively soft and resilient, compared to materials typically used to polish workpiece surfaces. By way of examples, the soft polymer-based material has a tensile modulus of about 50 kPa to about 1.0 MPa, about 50 kPa to about 500 kPa, or about 100 kPa to about 300 kPa. Additionally or alternatively, a compressibility at 300 gf/cm² of the soft polymer-based material is between about 40% and about 80%, about 50% and about 70%, or about 55% and about 65%. Soft polymer-based material 102 can have an elongation to break of about 400% to about 600%, about 450% to about 550%, or about 475% to about 525%. In accordance with further examples, a Shore A hardness of the soft polymer-based material is between about 0 and about 40, about 0 and about 20, or about 0 and about 10 and/or a Shore OO hardness of the soft polymer-based material is between about 10 and about 50, about 15 and about 40, or about 25 and about 35. A specific gravity of the soft polymer-based material can be 1.5 or less, less than 1, between about 0.8 and 1, or between about 0.92 and about 0.97. Soft polymer-based material 102 can be used to hold or retain other material, such as polymer material described below.

Soft polymer-based material 102 can comprise, consist of, or consist essentially of one or more of a plastisol (a material formed from a plastic resin dispersed in a plasticizer), a hydrogel (e.g., a polyacrylamide or polymacon hydrogel), an organogel (e.g., an organogel comprising one or more of 4-tertbutyl-1-aryl cyclohecanol derivatives; polymeric organogels, such as PEG, polycarbonate, polyesters, polyalkene, or N-lauroyl-L-lysine ethyl ester) and a silicone gel (e.g., polysiloxane or polydimethylsiloxane), alone or in combination with one or more other components (e.g., fillers, abrasives, and the like—e.g., as described herein). Exemplary plastic resins suitable for the formation of the polymer-based material include one or more of polyvinyl chloride and polyvinyl alcohol. Exemplary plasticizers include one or more compounds selected from the group consisting of benzoates, phthalates, glycerin, vegetable oils, organophosphates, azelates, adipates, sulfonamides, and polybutene.

Soft polymer-based material 102 can also include one or more fillers and/or abrasives. Exemplary fillers and abrasives include one or more polymeric and inorganic fillers, such as (inorganic) calcium carbonate, barium sulfate, cerium oxides, silicon oxides, aluminum oxides, zirconia, iron oxides, manganese dioxides, kaolin clays, montmorillonite clays, titanium oxides, silicon carbides, boron carbides, and diamond; (polymeric) polyurethane foam, epoxy, polystyrene, polyacrylic, polyimide, or other thermoplastic or thermoset materials. A size of the inorganic filler/abrasive particles can range from about 0.001 microns to about 1000 microns, or about 0.5 microns to about 3.0 microns average diameter. Organic polymeric fillers can also include cylindrical fibers ranging from 50 to 5000 microns in length and 10 to 1000 microns in diameter. Fillers can also include glass or polymeric microspheres and microballoons. The polymeric soft polymer-based material can include 0 to about 80 wt. % filler/abrasive. Exemplary organic inorganic filler/abrasive loading ranges from about 15 wt. % to about 30 wt. % or about 20 wt. % to about 25 wt. % by weight of the soft polymer-based material.

In the illustrated example, polishing media 100 also includes polymer material 104 at least partially dispersed in, embedded in, and/or attached (directly or indirectly) to the soft polymer-based material 102. The polymer material can be used to polish a surface of a workpiece and can be present in about 0 (e.g., greater than 0) to about 50%, about 5 wt. % to about 20 wt. %, or about 5 wt. % to about 10 wt. % of the polishing medium. In accordance with exemplary embodiments, polishing of a workpiece is performed exclusively or primarily by polymer material 104. Polymer material 104 can be concentrated near a top portion of polishing medium 100, and at least a portion of the polymer material 104 may not be encapsulated by soft polymer-based material 102. It is thought that by leaving at least a portion of polymer material 104 not encapsulated by soft polymer-based material 102, higher material removal rates can be achieved.

Polymer material 104 can include one or more of a polyurea, a polyurethane, and a polyurethane/polyurea hybrid material, any of which can be foamed. Polymer material 104 can include filler/abrasive material, such as the filler/abrasive material described herein. By way of example, polymer material 104 can include from 0 to about 80 wt. %, about 15 wt. % to about 30 wt. % or about 20 wt. % to about 25 wt. % by weight filler and/or abrasive. The weight percent is the weight percent of filler/abrasive in polymer material 104. Polymer material 104 may be formed into particles from sheets of material—such as material typically used to form polishing pads (e.g., new or used polishing pad material), which may be foamed. In this case, the particles can be formed by grinding (e.g., cryogenically), extruding (e.g., randomly orientated bristles), and/or cutting the polishing material. The particles can be sized, such that the particles are capable of passing through a ⅛ inch screen, a 0.1 inch screen, or a 0.05 inch screen. Alternatively, polymer material 104 can include material that is initially formed into particles of a desired size and/or shape. An average cross-sectional dimension of the polymer material 104 can range from about 10 nm to 500 microns. A density of polymer material 104 (e.g., of an inorganic filled polyurethane-polyurea hybrid material) can range from 0.3 to 2.0, or 0.3 to 1.0, or 0.4 to 0.6 g/cm³.

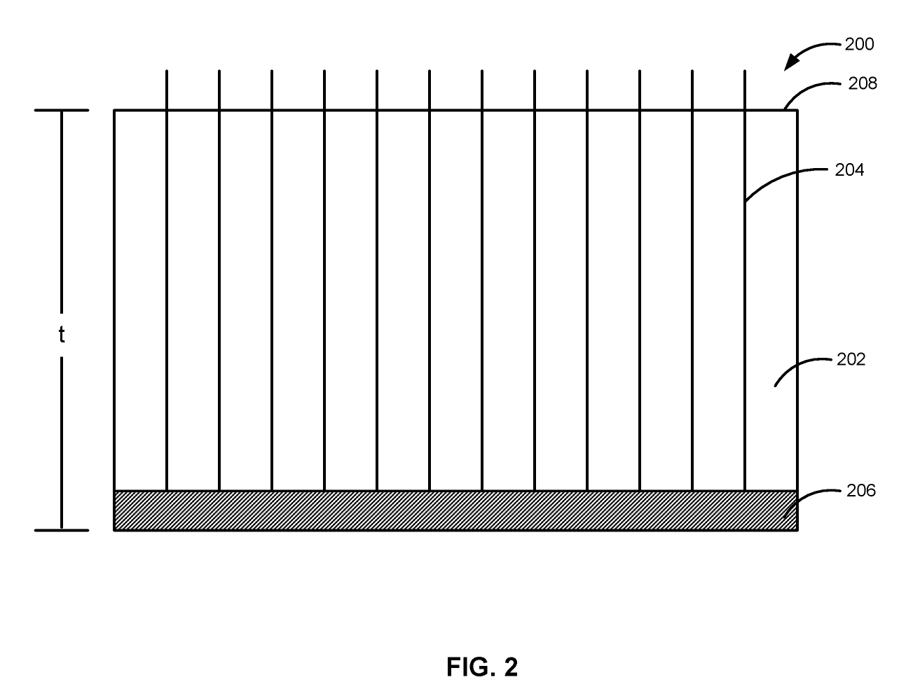

FIG. 2 illustrates a polishing medium 200, which includes bristles 204 embedded in a soft polymer-based material 202 (which can be the same as soft polymer-based material 102). Although not separately illustrated, polishing media in accordance with at least one embodiment of the disclosure can include both particles, as illustrated in FIG. 1, and bristles 204. Exemplary lengths of the bristles 204 range from 0.5 inch to 4 inches, or 1.0 inch to 3.0 inches or 2.0 inches to 2.5 inches, inches as measured from a surface of a plate 206 or other surface to which the bristles 204 are attached. A cross-sectional shape of the bristles can include a circle, square, rectangle, star, cross, triangle, or the like. An effective diameter of each bristle can range from 0.1 mm to 6 mm, or 0.5 mm to 4.0 mm, or 2.5 mm to 3.5 mm. A shape of a side profile (length) can be rectangular, triangular, or tapering. Bristles 204 can extend 0.1 to 2.0 inches from the soft polymer-based material 202 surface 208. Bristles 204 can comprise, consist of, or consist essentially of one or more of polyester, polyethylene, polypropylene, nylon and its various grades, animal hair, cut sections of nonwoven sheets, cut sections of polishing pads, polyurethane elastomer, and the like.

A thickness (t) of polishing medium 100 can vary according to various factors, including a thickness of a workpiece and/or one or more dimensions of nonplanar features therein or thereon. By way of examples, the thickness can range from about 0.25 to about 2.0 inches, about 0.5 to about 1.5 inches, or about 0.75 to about 1.25 inches in thickness.

Polishing media 100 and/or 200 can include vias formed through the soft polymer-based material 102, 202. The vias can facilitate slurry retention and/or adhesion of the media to a substrate. The vias can have a substantially columnar shape, with an average cross-sectional dimension of about 0.05 to about 1.0, about 0.02 to about 0.5, or about 0.2 to about 0.4 inches. Additionally or alternatively, polishing media 100 and/or 200 can include grooves (e.g., formed during a molding process) formed within a surface of the polishing medium. Exemplary grooves are typically formed in an x-y square grid, concentric circles, or spirals. Further, polishing medium 100 or 200 can have a surface that has a convex or concave shape, e.g., in a circular or parabolic curvature.

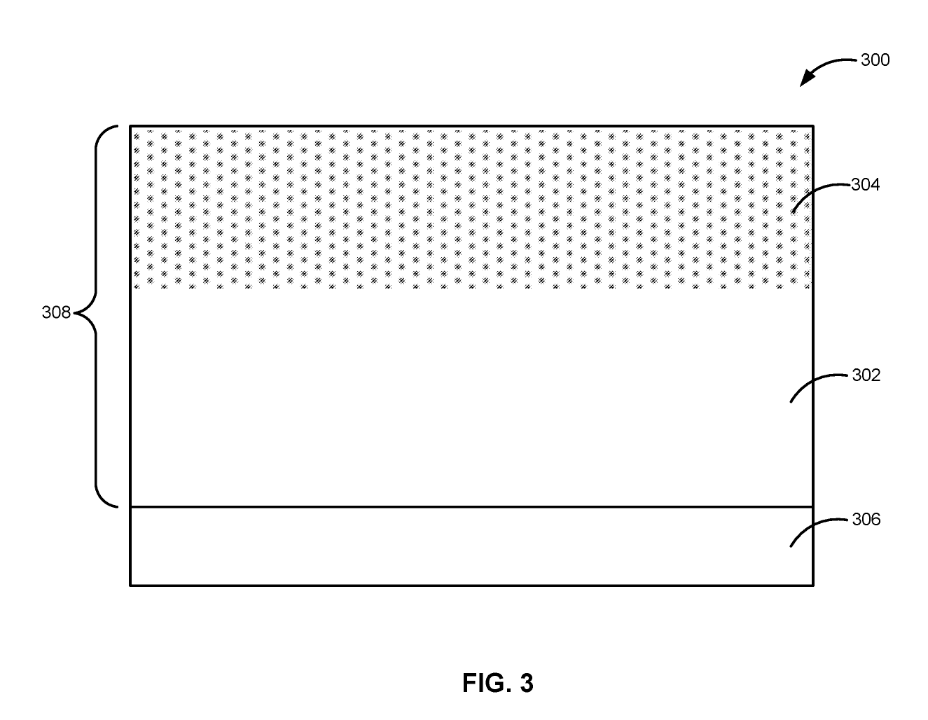

FIG. 3 illustrates a polishing apparatus 300 in accordance with at least one embodiment of the disclosure. Polishing apparatus 300 includes a plate 306 and polishing media 308. In the illustrated example, polishing media 308 includes soft polymer-based material 306 (which can be the same as soft polymer-based material 102, 202) and polymer material 304 (which can be the same as polymer material 104 and/or bristles 204).

Plate 306 and plate 206 can include any suitable material, such as plastic; for example, one or more of polypropylene, polyethylene, polycarbonate, polyamide, polyimide or other common rigid engineering plastics, or a metal. Plate 306 can be used to provide structural support for polishing medium 308. Holes or apertures can be formed within plate 306 to facilitate attachment of bristles thereto and/or adhesion of soft polymer-based material 302 to plate 306.

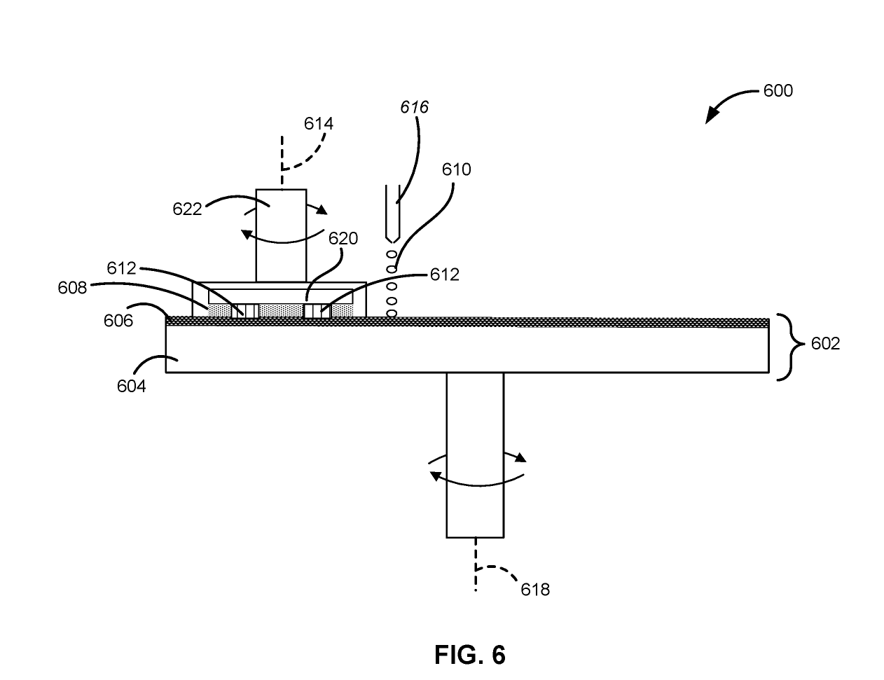

FIG. 6 illustrates an exemplary polishing system 600 in accordance with embodiments of the disclosure. Polishing system 600 can be used for polishing a workpiece 612—e.g., a workpiece having one or more profiles illustrated in FIG. 7. Polishing system 600 includes an apparatus 602, a carrier 608, and slurry 610, which can be dispensed from an optional slurry dispenser 616. Polishing system 600 can also include a weight 620 and/or a rotational arm 622. Apparatus 602, carrier 608, and slurry dispenser 661 can form part of a polishing machine or polisher.

Apparatus 602 includes a platen or plate 604 and medium 606 removably attached to platen 604. Apparatus 602 can rotate about an axis 618, as illustrated, and/or can perform other relative movement with respect to the workpiece 612 surface.

Carrier 608 can be configured to retain one or more workpieces during a polishing process. The carrier can include teeth that engage with, e.g., a platen of polishing system 600. If used, weight 620 can be of desired weight and can be separate or integral with carrier 608. Carrier 608 can rotate about axis 614, about axis 618, or employ other suitable movement. Carrier 608 can be formed of any suitable material. By way of examples, carrier 608 is formed of stainless steel and/or fiberglass.

Media, such as polishing medium 100 and/or 200, as described herein can be formed in a variety of ways, depending on the soft polymer-based material. Examples of techniques to form the soft polymer-based material are provided below. It is not intended that the invention be limited to these examples.

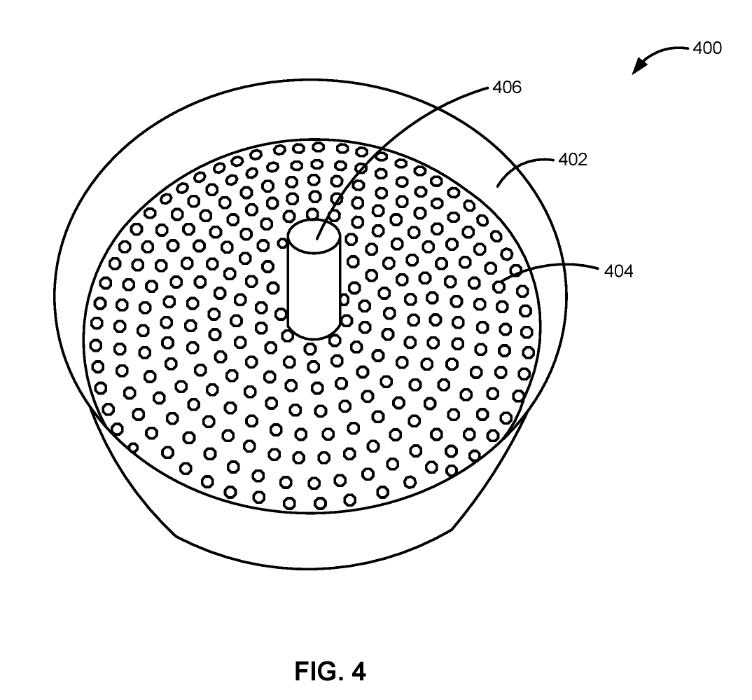

Plastisols: A method of forming a medium for polishing a surface of a workpiece includes the steps of: mixing one or more plastic resins and one or more plasticizers to form a mixture, heating the mixture to dissolve the plastic resin in the plasticizer to form a composition, pouring the composition into a mold (e.g., mold 402 in FIG. 4), and allowing the composition to cool to thereby form a soft polymer-based polishing medium. The one or more plastic resins can comprise one or more of polyvinyl chloride and polyvinyl alcohol, and the one or more plasticizers can comprise one or more compounds selected from the group consisting of benzoates, phthalates, glycerin, vegetable oils, organophosphates, azelates, adipates, sulfonamides, and polybutene. The step of heating can include heating the mixture to a temperature of about 340° C. to about 360° C., about 320° C. to about 380° C., or about 300° C. to about 400° C. A duration of the step of allowing the composition to cool can be about 8 hours or more at 68-72° F. FIG. 4 illustrates mold 402 before the composition is added to the mold. A plate 404 can be placed at the bottom of mold 402. Additionally, a post 406 can be used to form a via within the polishing medium to facilitate attachment of the medium to the polishing machine. Additional posts can be used to form vias for slurry. An exemplary pre-mixed plastisol compound is available from Aluminite under the name Alumisol. A softener or hardener can be used to adjust physical properties of the soft polymer-based material.

Exemplary methods can further include a step of mixing one or more polymer materials (e.g., particles and/or bristles, as described above) with the one or more plastic resins, the one or more plasticizers, and/or the mixture and/or adding one or more fillers, abrasives and/or fibers to the one or more plastic resins, the one or more plasticizers, or the mixture. For example, the polymer material (e.g., about ¼ thick layer) can be added to and then pressed into the compound as the compound begins to cool. At least a portion of the polymer material surface can be exposed (i.e., not encapsulated), so as to be available for polishing a workpiece surface.

Hydrogels: An acrylamide monomer can be free-radical polymerized using sulfate radicals and then crosslinked with N,N′-methylenebisacrylamide. Ratios of acrylamide monomer to crosslinker help determine the physical properties (e.g., properties noted herein) of the resulting gel. The resulting gel is hydrophilic from the high concentration of primary amine (—NH2) groups. An aqueous buffer solution is added to swell the matrix and create the hydrogel.

Exemplary methods can further include a step of mixing one or more polymer materials (e.g., particles and/or bristles, as described above) with the acrylamide monomer or the aqueous buffer solution and/or adding one or more fillers, abrasives and/or fibers to the acrylamide monomer or the aqueous buffer solution.

Organogels: An organogelator such as polyethylene glycol (PEG) is heated in an apolar solvent and then cooled down below the solubility limit of the organogelator. The organogelator will then precipitate out as a fiber, forming a 3-dimensional network which then immobilizes the apolar solvent to produce an organogel.

Exemplary methods can further include a step of mixing one or more polymer materials (e.g., particles and/or bristles, as described above) with the organogelator or the apolar solvent and/or adding one or more fillers, abrasives and/or fibers to the organogelator or the apolar solvent.

Silicone Gel: By way of example, polydimethylsiloxane (PDMS) can be polymerized by hydrolysis of a dimethyldichlorosilane monomer. This reaction results in linear chains of alternating (—Si—O—Si—) backbone with methyl groups on each Si atom. Soft PDMS is not highly crosslinked but may contain various amounts of crosslinkers such as methyltrichlorosilane to create branchpoints in the PDMS matrix to influence hardness. As with previous examples, polymer materials (e.g., particles and/or bristles, as described above) and/or one or more fillers, abrasives and/or fibers can be added to a compound to form a medium as described herein.

With any of the examples above, grooves can be formed on a surface of the media during the manufacturing process. Such grooves can be formed using, for example, a mold or an injection mold process.

As noted above, media, apparatus and/or systems as described herein can be used to remove material from nonplanar workpiece surfaces. The table below illustrates removal rates of aluminosilicate glass (MRR) using various materials. The “preferred embodiment” examples are formed according to various embodiments of this disclosure.

TABLE 1

| | Boarhair + | Standard | | Soft PU | Hard PU | Non- | Commercial | Commercial | Preferred |
|---|---|---|---|---|---|---|---|---|---|
| | Non-Woven | Polyurethane | Neoprene | Elastomer | Elastomer | Woven | Carpet | Carpet 2 | Embodiment |
| Average MRR | 0.085 | 0.035 | 0.014 | 0.013 | 0.056 | 0.124 | 0.219 | 0.269 | 0.262 |
| (□m/min) | | | | | | | | | |

The polishing medium of the preferred embodiments had the properties listed in Table 2. The polishing media included ground polymer material that passed through a ⅛″ screen. The ground polymer material was placed on top of the compound in a layer around 0.25 inches thick, so at least a portion of the polymer material extended beyond a surface of the soft polymer-based material.

Various examples in accordance with this disclosure include the following.

1. A polishing medium comprising a soft polymer-based material, the soft polymer-based material having a tensile modulus of about 50 kPa to about 1.0 MPa, about 50 kPa to about 500 kPa, or about 100 kPa to about 300 kPa.

2. The polishing medium of example 1, wherein the compressibility at 300 gf/cm² of the soft polymer-based material is between about 40% and about 80%, about 50% and about 70%, or about 55% and about 65%.

3. The polishing medium of any of examples 1 and 2, wherein soft polymer-based material comprises a plastic resin dispersed in a plasticizer.

4. The polishing medium of example 3, wherein the plastic resin comprises one or more of polyvinyl chloride and polyvinyl alcohol.

5. The polishing medium of any of examples 3 and 4, wherein the plasticizer comprises one or more compounds selected from the group consisting of benzoates, phthalates, glycerin, vegetable oils, organophosphates, azelates, adipates, sulfonamides, and polybutene.

6. The polishing medium of any of examples 3-5, wherein the soft polymer-based material comprises one or more of the plastic resin and the plasticizer, a hydrogel (e.g., a polyacrylamide or polymacon hydrogel), an organogel (e.g., an organogel comprising one or more of 4-tertbutyl-1-aryl cyclohecanol derivatives; polymeric organogels, such as PEG, polycarbonate, polyesters, polyalkene, or N-lauroyl-L-lysine ethyl ester) and a silicone gel (e.g., polysiloxane or polydimethylsiloxane).

7. The polishing medium of examples 1-6, wherein soft polymer-based material is about 0.25 to about 2.0 inches, about 0.5 to about 1.5 inches, or about 0.75 to about 1.25 inches in thickness.

8. The polishing medium of examples 1-7, wherein the polishing medium further comprises polymer material. The polymer material can be at least partially dispersed in the soft polymer-based material or attached to the soft polymer-based material. The polymer material can be present in about 0 to about 50%, about 5 wt. % to about 20 wt. %, or about 5 wt. % to about 10 wt. % of the polishing medium.

9. The polishing medium of example 8, wherein the polymer material comprises one or more of a polyurea, a polyurethane, and a polyurethane/polyurea hybrid material, any of which can be foamed. A density of the polymer material (e.g., of an inorganic filled polyurethane-polyurea hybrid material) can range from 0.3 to 2.0, or 0.3 to 1.0, or 0.4 to 0.6 g/cm³. The polymer material can include an organic or inorganic filler in an about of 0 to about 80 wt. %, about 15 wt. % to about 30 wt. %, or about 20 wt. % to about 25 wt. % by weight of the polymer material.

10. The polishing medium of any of examples 8 and 9, wherein the polymer material is capable of passing through a ⅛ inch screen, a 0.1 inch screen, or a 0.05 inch screen.

11. The polishing medium of any of examples 8-10, wherein the polymer material comprises pieces or particles (e.g., ground) polishing pad material.

12. The polishing medium of any of examples 8-11, wherein the polymer material comprises ground used polishing pad material.

13. The polishing medium of any of examples 8-12, wherein the soft polymer-based material comprises a layer 0.02 to 0.5 inches, 0.1 to 0.25 inches, or 0.1 to 0.2 inches thick of polymer material encapsulated at least partially by the soft polymer-based material, wherein a portion of the polymer material is or may be left exposed to contact the polishing workpiece surface during a polishing process.

14. The polishing medium of any of examples 1-13, wherein the Shore A hardness of the soft polymer-based material is between about 0 and about 40, about 0 and about 20, or about 0 and about 10 and/or a Shore 00 hardness of the soft polymer-based material is between about 10 and about 50, about 15 and about 40, or about 25 and about 35.

15. The polishing medium of any of examples 1-14, wherein the polishing medium comprises vias formed through the soft polymer-based material.

16. The polishing medium of any of examples 1-15, further comprising one or more fillers and/or abrasives.

17. The polishing medium of example 16, wherein the one or more fillers and/or abrasives comprise one or more organic and inorganic fillers, such as (inorganic) calcium carbonate, barium sulfate, cerium oxides, silicon oxides, aluminum oxides, zirconia, iron oxides, manganese dioxides, kaolin clays, montmorillonite clays, titanium oxides, silicon carbides, boron carbides, and diamond; (polymeric) polyurethane foam, epoxy, polystyrene, polyacrylic, polyimide, or other thermoplastic or thermoset materials. A size of the inorganic filler/abrasive particles can range from about 0.001 microns to about 1000 microns, or about 0.5 microns to about 3.0 microns average diameter. Organic polymeric fillers can also include cylindrical fibers ranging from 50 to 5000 microns in length and 10 to 1000 microns in diameter. Fillers can also include glass or polymeric microspheres and microballoons. The polymer material and/or the soft polymer-based material can include 0 to about 80 wt. % filler/abrasive. Exemplary inorganic filler/abrasive loading in either material ranges from about 15 wt. % to about 30 wt. % or about 20 wt. % to about 25 wt. % by weight.

18. The polishing medium of any of examples 1-17, wherein the polishing medium comprises grooves formed within a surface (e.g., top or polishing surface) of the polishing medium.

19. The polishing medium of any of examples 1-18 wherein the polishing medium comprises bristles, such as to form a flexible brush. Exemplary lengths of the bristles range from 0.5 inch to 4 inches, or 1.0 inch to 3.0 inches or 2.0 inches to 2.5 inches, inches as measured from a surface of the plate or substrate to which the bristles are attached. A cross-sectional shape of the bristles can include a circle, square, rectangle, star, cross, triangle, or the like. An effective diameter of each bristle can range from 0.1 mm to 6 mm, or 0.5 mm to 4.0 mm, or 2.5 mm to 3.5 mm. A shape of a side profile (length) can be rectangular, triangular, or tapering.

20. The polishing medium of any examples of 1-19 wherein the polishing medium has a surface that has a convex or concave circular curvature.

21. The polishing medium of any of examples 1-20, wherein the soft polymer-based material has an elongation to break of about 400% to about 600%, about 450% to about 550%, or about 475% to about 525%.

22. The polishing medium of any of examples 1-21, wherein the soft polymer-based material has a specific gravity of 1.5 or less, less than 1, between about 0.8 and 1, or between about 0.92 and about 0.97.

23. A polishing apparatus comprising the polishing medium of any of examples 1-22.

24. The polishing apparatus of example 23, further comprising a plate, the polishing medium coupled to a surface of a plate.

25. The polishing apparatus of example 24, wherein the plate comprises plastic, such as polypropylene, polyethylene, polycarbonate, polyamide, polyimide or other common rigid engineering plastics, or a metal.

26. A polishing system comprising the polishing apparatus of any of examples 23-25.

27. The polishing system of example 26, further comprising a slurry.

28. The polishing system of any of examples 26 and 27, further comprising a polishing machine.

29. A method of forming a medium for polishing a surface of a workpiece, the method comprising the steps of:

mixing one or more plastic resins and one or more plasticizers to form a mixture; heating the mixture to dissolve the plastic resin in the plasticizer to form a composition; pouring the composition into a mold; and allowing the composition to cool to thereby form a soft polymer-based polishing medium.

30. The method of example 29, further comprising the step of mixing one or more polymer materials with the one or more plastic resins, the one or more plasticizers, and/or the mixture. An average cross-sectional dimension of the polymer material can range from about 10 nm to 500 microns.

31. The method of any of examples 29 and 30, further comprising the step of mixing one or more of the polymeric materials selected from the group consisting of the polyurethane material, the polyurea material, and the hybrid polyurethane/polyurea material with the one or more plastic resins, the one or more plasticizers, and/or the mixture.

32. The method of any of examples 29-31, further comprising the step of mixing or adding bristles with the one or more plastic resins, the one or more plasticizers, and/or the mixture.

33. The method of example 32, wherein the soft polymer-based material is molded around brush bristles that are connected to the plate. The brush bristles can extend 0.1 to 2.0 inches from the soft polymer-based surface. The brush bristles can comprise, consist of, or consist essentially of polyester, polyethylene, polypropylene, nylon and its various grades, animal hair, cut sections of nonwoven sheets, cut sections of polishing pads, and polyurethane elastomer.

34. The method of any of examples 29-33, wherein the one or more plastic resins comprise one or more of polyvinyl chloride and polyvinyl alcohol.

35. The method of any of examples 29-34, wherein the one or more plasticizers comprise one or more compounds selected from the group consisting of benzoates, phthalates, glycerin, vegetable oils, organophosphates, azelates, adipates, sulfonamides, and polybutene.

36. The method of any of examples 29-35, wherein the polymer material comprises ground polishing pad material.

37. The method of any of examples 29-36, wherein the polymer material comprises ground used polishing pad material.

38. The method of any of examples 27-35, wherein the step of heating comprises heating the mixture to a temperature of about 340° C. to about 360° C., about 320° C. to about 380° C., or about 300° C. to about 400° C.

39. The method of any of examples 29-37, wherein a duration of the step of allowing the composition to cool is of about 8 hours or more at 68-72° F.

40. The method of any of examples 29-39, further comprising a step of providing a plastic plate within the mold.

41. The method of any of examples 29-40, further comprising adding one or more fillers, abrasives and/or fibers to the one or more plastic resins, the one or more plasticizers, or the mixture.

42. A method of removing material from a workpiece surface using the polishing medium of any of examples 1-22, the polishing apparatus of any of examples 23-25, the polishing system of any of examples 26-28, or polishing media formed according to any of examples 29-41. The methods can be used to remove material from planar and/or nonplanar surfaces.

43. The method of claim 42, wherein a workpiece from which material is removed comprises one or more of glass, sapphire, semiconductor material, and a layer used in the formation of an electronic device.

Although exemplary embodiments of the present disclosure are set forth herein, it should be appreciated that the disclosure is not so limited. For example, although materials, media, apparatus, systems, and methods are described in connection with lapping hard-surface materials, the invention is not so limited—unless otherwise stated. Various modifications, variations, and enhancements of the materials, methods, and media set forth herein may be made without departing from the spirit and scope of this disclosure.

I claim:

1. A polishing medium comprising:
a soft polymer-based material, the soft polymer-based material having a tensile modulus of about 50 kPa to about 1.0 MPa, and
a polymer material at least partially dispersed in the soft polymer-based material or attached to the soft polymer-based material.

2. The polishing medium of claim 1, wherein the polishing medium comprises about 5 wt. % to about 20 wt. % polymer material.

3. The polishing medium of claim 1, wherein the polymer material performs polishing of a workpiece.

4. The polishing medium of claim 1, wherein the polymer material comprises one or more of a polyurea, a polyurethane, and a polyurethane/polyurea hybrid material.

5. The polishing medium of claim 4, wherein the polymer material is foamed.

6. The polishing medium of claim 1, wherein the polymer material comprises one or more of pieces and particles of polishing pad material.

7. The polishing medium of claim 1, wherein one or more of the soft polymer-based material and the polymer material comprises one or more of a filler and an abrasive.

8. The polishing medium of claim 1, wherein the polymer material comprises one or more of a filler and an abrasive selected from the group consisting of calcium carbonate, barium sulfate, cerium oxides, silicon oxides, aluminum oxides, zirconia, iron oxides, manganese dioxides, kaolin clays, montmorillonite clays, titanium oxides, silicon carbides, boron carbides, diamond, polyurethane foam, epoxy, polystyrene, polyacrylic, polyimide, and other thermoplastic or thermoset materials.

9. The polishing medium of claim 1, wherein a density of the polymer material ranges from about 0.3 to about 2.0 g/cm³.

10. The polishing medium of claim 1, wherein the polymer material comprises one or more of bristles, cubes, or other pieces to perform polishing of a workpiece.

11. The polishing medium of claim 1, wherein the soft polymer-based material comprises one or more of a plastic resin, a hydrogel, an organogel, and a silicone gel.

12. A polishing medium comprising:
a soft polymer-based material, and
a polymer material at least partially embedded in or attached to the soft polymer-based material,
wherein a Shore OO hardness of the soft polymer-based material is between about 10 and about 50.

13. The polishing medium of claim 12, wherein the polymer material comprises one or more of cylindrical fibers, microspheres, and microballoons.

14. The polishing medium of claim 12, wherein a density of the polymer material ranges from about 0.3 to about 2.0 g/cm³.

15. The polishing medium of claim 12, wherein one or more of the soft polymer-based material and the polymer material comprises one or more of a filler and an abrasive.

16. The polishing medium of claim 12, wherein a surface of the polishing medium comprises grooves.

17. The polishing medium of claim 12, wherein the polymer material comprises one or more of bristles, cubes, or other pieces to perform polishing of a workpiece.

18. The polishing medium of claim 12, wherein the polymer material comprises one or more of a polyurea, a polyurethane, and a polyurethane/polyurea hybrid material.

19. The polishing medium of claim 12, wherein the polymer material comprises one or more of pieces and particles of polishing pad material.

20. A method of removing material from a workpiece surface using the polishing medium of claim 1.
